(19) United States
(12) Patent Application Publication
(10) Pub. No.: US 2006/0165004 A1
(43) Pub. Date: Jul. 27, 2006

(54) Method and system to analyze digital cross-connect system equipment and software

(76) Inventors: Mark A. Steele, Lake Dallas, TX (US); Anthony Edward Hanson, Dallas, TX (US)

Correspondence Address: MATTHEW E. BURR;LAKE AUSTIN MARINA, 2219 WESTLAKE DR, STE 200, AUSTIN, TX, 78746, US

(21) Appl. No.: 10/988,983

(22) Filed: Nov. 15, 2004

(51) Int. Cl. H04J 1/16; H04J 3/14

(52) U.S. Cl. 370/250

(57) ABSTRACT

Methods and systems in a communications network to look at all of the DACS II output and determine whether a fault exists. If a fault is determined to exist, then an email is sent to the appropriate users notifying them that a problem has occurred. Three computer program commands, for example, are set up to automatically be sent to the network elements at a selected time everyday. The response to the commands is automatically emailed to a specified UNIX server. At 0600, for example, the program automatically kicks off the 3 commands and analyzes the data from the responses to the commands. If the program finds a fault in the command outputs, the program will then post what the fault is on a website. In various embodiments, the software also automatically kicks off an email to a distribution list in the program. The email can go to anybody that requests to be on it. For example, it is sent to an Network Operations Center, where the fault is responded to. The whole process is automated, including the emailing or web page posting of any faults found.

### FIELD OF THE INVENTION

The invention pertains to the field of multiplexed telecommunications. More particularly, the invention pertains to methods and systems to analyze the output from multiplexers and cross-connect systems in a telecommunications network.

### BACKGROUND OF THE INVENTION

Digital cross-connect (DCS”) systems, such as the Lucent™ DACS or DACS II products, were developed to route data across a multiplexed network having many sources and destinations and carrying many kinds of information. Essentially, a DCS is digital telecommunications switching system that includes dedicated hardware with software to accomplish call switching.

The information might be a digitized audio conversation between two telephones (termed “duplex” or two-way communications), a data stream from a sensor to a data recorder or computer (“simplex” or one-way transmission), or a transmission from one location to a number of displays (a “multicast”). Several users might be connected in a conference call setup.

A DCS is a network element that terminates digital signal systems at a particular bit rate, but allows the direct interchange of component signals at a lower bit rate. A DCS 1/0, for example, terminates DS1 systems and interchanges DS0 bit rate channels. A DCS 1/1 interchanges DS1 bit rate channels. A DCS 3/1 has a DS1 interchange, but also allows a DS3 level interface which is demultiplexed to DS1 for switching. A DCS 3/3 has both a DS3 interface and DS3 cross-connect.

A Digital Access Cross-Connect System (DACS) is an electronic digital cross-connect system manufactured by Lucent Technologies Network Systems that has the capability to rearrange the digital signal components of a particular transmission rate. For example, the DACS IV-2000 System is a DS1 cross-connect, and the DACS III-2000 is a DS3 cross-connect.

The most common digitization technique, historically, was pulse code modulation (PCM). In telephone audio usage this involves taking 8000 samples/second of the analog waveform and quantizing it to 8 bit precision with an analog to digital (A/D) converter. When the bits are serially shifted out, the signal source is called a “DS0”, in the North American telecommunications terminology. The “DS0” terminology refers to a well-defined transmission rate and coding scheme in the time-division multiplex hierarchy.

The DACS II (Digital Access Cross-Connect System II) consists of the multi-bay Capacity Expansion Frame (CEF), which is also available in an enclosed (ECEF) version that meets European environmental requirements. With these systems, the DACS II line has a Digital Cross-Connect System (DCS) for network applications of 384 E1s/480 DS1s in two bays and up to 2,048 E1 s/2560 DS1s in seven bays.

The term DS0 generally applies to the 64 Kb component of a DS1 signal that represents the equivalent of a voice channel. Digital signal rates and signal templates are documented by industry standards organizations such as the American National Standards Institute (ANSI), the Conference of European Postal and Telecommunications Administrations, and the CCITT. Examples of the North American digital hierarchy include DS1 (operating at 1.544 Mb/s per second), DS1 C (3.152 Mb/s), and DS3 (44.736 Mb/s). Four DS1s can be combined into a DS2; DS2s compose a DS3. There are also DS4's and DS5's, used for long-distance trunks often running on optical fiber.

A Synchronous Optical Network (SONET) is a set of standards for transmission systems operating over optic fiber. The SONET standard is based on the DS3 signal with, among other things, added bits for overhead information. The basic building block is the Synchronous Transport Level-1 (STS-1) or the Optical Carrier Level-1 (OC-1) at 51.84 Mb/s. The standard provides for higher bit-rate transmission of STS-n and OC-n, where n=1, 3, 9, 12, 18, 24, 36, 48.

The invention described here analyzes the multiplexer and cross-connect systems for a telecommunications network to detect software or performance errors. The invention also reviews DCS output, which is in the form of ones and zeros. The output is often reviewed, presently, by eye by a human, which is a recipe for compounded error.

### BRIEF DESCRIPTION OF THE DRAWING

The present invention is further described in the detailed description that follows, by reference to the noted drawing, by way of non-limiting examples of embodiments of the present invention, in which reference numerals represent similar steps throughout the view of the drawing, and in which:

FIG. 1 is high level logic flow chart of a software computer application of a specific embodiment of the present invention.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to Lucent DACS II. It is understood that a DACS II is merely an example of a specific embodiment of the present invention, which is directed generically to digital cross-connect systems and equipment, together with attendant networks, systems and methods within the scope of the invention. The terminology, therefore, is not intended to limit the scope of the invention.

A switch can connect Ethernet, Token Ring, or other types of packet switched network segments together to form a heterogenous network operating at OSI Layer 2. In telecommunications, the term framing has the following meanings: (1) in time-division multiplexing reception, it is a synonym for frame synchronization; (2) In video reception, it is the process of adjusting the timing of the receiver to coincide with the received video synchronization pulse; and (3) In facsimile, the adjustment of the facsimile picture to a desired position in the direction of scan line progression.

As a frame comes into a switch, the switch saves the originating MAC address and the originating port in the switch's MAC address table. The switch then selectively transmits frames out specific ports based on the frames destination MAC address and previous entries in the MAC address table. If the MAC address is unknown, or a broadcast or multicast address, the switch simply floods the frame out all of the connected interfaces except the incoming port. If the destination MAC address is known, the frame is forwarded only to the corresponding port in the MAC address table. If the destination port is the same as the originating port, the frame is filtered out and not forwarded.

Switches, unlike hubs, use microsegmentation to divide collision domains, one per connected segment. The NICs which are directly connected via a point-to-point link, or directly connected hubs contend for the medium. By nearly eliminating the possibility of collisions, full-duplex point-to-point connections on the switch become possible. Virtual LANs can be used in switches to reduce the size of the broadcast domains and at the same time increase security. In redundant architectures, spanning tree protocol can be used in switches to prevent loops.

The forwarding methods a switch can use include (1) Store and Forward—the switch, unlike cut through, buffers and typically performs a checksum on each frame before forwarding it on; (2) Fragment free switching; and (3) Adaptive Switching.

Switches introduce difficulties to the task of monitoring traffic, however, because each port is isolated until it transmits data, and even then only the sending and receiving ports are connected. Two popular methods that are specifically designed to allow a network manager to monitor traffic are:

1. Port mirroring—the switch sends a copy of network packets to a monitoring network connection.

2. SMON—“Switch Monitoring” is a protocol for controlling facilities such as port mirroring.

Other methods have been devised to allow snooping on another computer on the network without the cooperation of the switch:

1. ARP spoofing—fooling the target computer into using your own MAC address for the network gateway, or alternatively getting it to use the broadcast MAC.

2. MAC flooding—overloading the switch with a large number of MAC addresses, so that it drops into a “failopen mode”.

A router, as distinguished from a switch, is a computer networking device that forwards data packets toward their destinations through a process known as routing. Routing occurs at layer 3 of the OSI seven-layer model. Routing is most commonly associated with the Internet Protocol, although other less-popular routed protocols remain in use.

In the original 1960s-era of routing, general-purpose computers served as routers. Although general-purpose computers can perform routing, modern high-speed routers are highly specialised computers, generally with extra hardware added to accelerate both common routing functions such as packet forwarding and specialised functions such as IPSec encryption.

Modern routers have thus come to resemble telephone switches. The technologies are converging and routers may eventually replace switches. The first modern (dedicated, standalone) routers were the Fuzzball routers.

A router must be connected to at least two networks, or it will have nothing to route. A special variety of router is the one-armed router used to route packets in a virtual LAN environment. In the case of a one-armed router the multiple attachments to different networks are all over the same physical link. A router that connects end-users to the Internet is called Edge router. A router that transmits data between other routers is called Core router.

A router creates and/or maintains a table, called a “routing table” that stores the best routes to certain network destinations and the “routing metrics” associated with those routes. In recent times many routing functions have been added to LAN switches, creating “Layer 2/3 Switches” which route traffic at near wire speed. Routers are also now being implemented as Internet gateways, primarily for small networks like those used in homes and small offices. This application is mainly where the Internet connection is an always-on broadband connection like cable modem or DSL. These are not “routers” in the true sense, but the terminology has been confused with network address translation.

Locations or nodes with electronic cross-connects are called main sites, and these sites are interconnected with fiber optic (e.g., SONET) multiplexers. The distances between these sites may be tens of miles apart and the network may have many more sites than are shown here. The sites are connected by links, which might be optical, wired, radio, satellite or microwave, as desired. The overall network can be configured as a ring, and possibly by secondary links between high-traffic locations.

Most of these multiplexers have connections to smaller sites called “feeder sites” that connect to the DS0 and wideband signals at those sites that need to be interconnected across the range. A multiplexer that connects to one or more feeder sites is called a breakout site. Main sites may also function as breakout sites.

In each of the sites, one or more feeder sites, which communicate with their users via DS0-level signals, are connected to SONET OC-3 multiplexers via DS1 signals. In the main site, the OC-3 is connected to a DCS 3/1 digital cross-connect which in turn is connected via DS3 lines to a DCS 1/0 cross-connect. In the breakout site, the OC-3 multiplexer connects directly to the OC-48 multiplexer.

In a breakout site, the DS1 signals from the feeder sites are “hard wired” to the OC-3 SONET multiplexer, but these multiplexers can change the locations of these DS1 signals within the OC-3 multiplexer electronically.

Similarly, in a main site, the digital cross-connects DCS 3/1 and DCS 1/0 can change the location of DS0 and DS1 signals within the DS3 signals that are connected to the OC-48 multiplexer. The DS1 to be cross-connected does not have to have a DS0 within it. An entire “clear channel” DS1, i.e., no channelization for DS0 circuits, can be cross-connected.

Accompanied by a range of Integrated Access Devices placed at the network edge, Lucent™ DACS II delivers an end-to-end network solution that may be managed with the DACS Network Director or the portable DACS II View, both of which offer remote management capabilities for DACS II operation. It supports network applications of 384 E1s/480 DS1s in two bays and up to 2,048 E1s/2,560 DS1s in seven bays.

DACS II provides carrier-grade operation and the ability to change capacity to easily introduce new services. It operates at a high level of reliability with robust hardware, redundancy for critical equipment and service paths, and a rugged software system core. DACS II reduces cost and risks associated with implementing new services via the DSP platform.

In communications systems, a cross-connect system is a digital system in which (a) access is performed by T-1 hardware architecture in private and public networks with centralized switching; and (b) cross-connection is performed by D3/D4 framing for switching digital-signal-0 (DS-0) channels to other DS-0 channels. Modern digital access and cross-connect systems are not limited to the T-carrier system, and may accommodate high data rates such as those of SONET.

The present invention provides computer-readable code that instructs a computer to analyze the output of 3 separate commands from the Lucent DACS II. The output of these commands is long and it is very time consuming to go through each output by eye to look for problems. The output is mostly in the form of 1's and 0's and human error is often involved in a manual search through the output information. For an example, see Table 1.

TABLE 1
EXAMPLE OF DACS II OUTPUT:

LOCATION: AUSTTXGRK01
COMMAND: UTL::QRY,MEMSTAT
M 12:40:59 01,37 609 UTL QRY MEMSTAT 5 LN MSG:

| DEV | EXCT | DBASE | DATE | TIME | FID | UID | |
|---|---|---|---|---|---|---|---|
| RAM | 07.00.- | 07.00.- | 07/02/04 | 12:40:57 | 01 | AUSTTXGRK01 | |
| PMEM | 07.00.- | 07.00.- | 07/02/04 | 11:30:19 | 01 | AUSTTXGRK01 | |
| SMEM | 07.00.- | 07.00.- | 07/02/04 | 11:30:19 | 01 | AUSTTXGRK01 | EOM |

M 12:40:59 01,37 609 UTL QRY MEMSTAT 5 LN MSG:

| | | | | |
|---|---|---|---|---|
| FPKG | DBSN | FCSN | STATE | |
| 00000b9d | 1234567890 | 1234567890 | IS | |
| 00000b9d | 1234567890 | MZX00510498 | IS | |
| 00000b9d | 1234567890 | 001701E1903V4228 | IS | COMPL |

LOCATION: AUSTTXGRK01
COMMAND: UTL::QRY,ALMS
M 12:41:11 01,38 609 UTL QRY ALMS SUMMARY CR 1 MJ 0 MN 1 MC 0 PWR 0 EOM
M 12:41:11 01,38 609 UTL QRY ALMS PWR 2 LN MSG:
- - - - - - - - - - - - - - - - - - - - EOM
M 12:41:11 01,38 609 UTL QRY ALMS - - - - - - - - - - - - - - - - - - -
EOM
M 12:41:11 01,38 609 UTL QRY ALMS 3 LN MSG:
SYNC - - CRO -
TLI - - - - - - - - - - - - - - - - EOM
M 12:41:11 01,38 609 UTL QRY ALMS TOTAL ETSIS 32 00 3 LN MSG:
01 - - 02 - - 03 - - 04 - - 05 - - 06 - - 07 - - 08 - -
09 - - 10 - - 11 - - 12 - - 13 - - 14 - - 15 - - 16 - - EOM
M 12:41:11 01,38 609 UTL QRY ALMS 5 LN MSG:
UNIT 01 UC - FTMI - - - - FC - - - - - - - -
UNIT 02 UC - FTMI - - - - FC - - - - - - - -
UNIT 03 UC - FLI - - FMT - - MXR - - - - - - - MIU - - - - - - - DU -
UNIT 04 UC - FTMI - - - - FC - - - - - - - - EOM
M 12:41:11 01,38 609 UTL QRY ALMS 5 LN MSG:
UNIT 05 UC - FTMI - - - - FC - - - - - - - -
UNIT 06 UC - DSPI -
UNIT 07 UC - FLI - - FMT - - MXR - - - - - - - MIU - - - - - - - DU -
UNIT 08 UC - FLI - - FMT - - MXR - - - - - - - MIU - - - - - - - DU -
EOM
M 12:41:11 01,38 609 UTL QRY ALMS 5 LN MSG:
UNIT 09 UC - FLI - - FMT - - MXR - - - - - - - MIU - - - - - - - DU -
UNIT 10 UC - FLI - - FMT - - MXR - - - - - - - MIU - - - - - - - DU -
UNIT 11 UC - FLI - - FMT - - MXR - - - - - - - MIU - - - - - - - DU -
UNIT 12 UC - FLI - - FMT - - MXR - - - - - - - MIU - - - - - - - DU -
EOM
M 12:41:11 01,38 609 UTL QRY ALMS 5 LN MSG:
UNIT 13 UC - FLI - - FMT - - MXR - - - - - - - MIU - - - - - - - DU -
UNIT 14 UC - FLI - - FMT - - MXR - - - - - - - MIU - - - - - - - DU -
UNIT 15 UC - FLI - - FMT - - MXR - - - - - - - MIU - - - - - - - DU -
UNIT 16 UC - FLI - - FMT - - MXR - - - - - - - MIU - - - - - - - DU -
EOM
LOCATION: AUSTTXGRK01
COMMAND: UTL::QRY,ALL
M 12:42:08 01,39 609 UTL QRY ALL COMMON 4 LN MSG:
OOS 0 0 0 0 1 0 0 0 0 0
FAIL - - - - - - - - 0 0
PEST - - - - - - 0 0 0 0 EOM
M 12:42:08 01,39 609 UTL QRY ALL COMMON 4 LN MSG:
SYNC 000 000 CRO ---
TLI --- --- --- --- --- --- 000 000 --- --- --- --- --- --- 000 000
- - - - - - 1 2 - - - - - - 1 2
EOM
M 12:42:09 01,39 609 UTL QRY ALL TOTAL ETSIS 32 00 00 00 5 LN MSG:
01 000 000 02 000 000 03 000 000 04 000 000
05 000 000 06 000 000 07 000 000 08 000 000
09 000 000 10 000 000 11 000 000 12 000 000
13 000 000 14 000 000 15 000 000 16 000 000 EOM
M 12:42:09 01,39 609 UTL QRY ALL FTU 3 LN MSG:
UNIT 01 UC 000 FTMI 000 000 000 000
FC 000 000 000 000 000 000 000 000 EOM
M 12:42:09 01,39 609 UTL QRY ALL FTU 3 LN MSG:
UNIT 02 UC 000 FTMI 000 000 000 000
FC 000 000 000 000 000 000 000 000 EOM
M 12:42:09 01,39 609 UTL QRY ALL DS3U 3 LN MSG:
UNIT 03 UC 000 FLI 000 000 FMT 000 000
MXR 000 000 000 --- 000 000 000 MIU --- --- --- --- --- --- --- EOM
M 12:42:09 01,39 609 UTL QRY ALL FTU 3 LN MSG:
UNIT 04 UC 000 FTMI 000 000 000 000
FC 000 000 000 000 000 000 000 000 EOM
M 12:42:10 01,39 609 UTL QRY ALL FTU 3 LN MSG:
UNIT 05 UC 000 FTMI 000 000 000 000
FC 000 000 000 000 000 000 000 000 EOM
M 12:42:10 01,39 609 UTL QRY ALL UNIT 06 UC 000 DSPI 000 EOM
M 12:42:10 01,39 609 UTL QRY ALL DS3U 3 LN MSG:
UNIT 07 UC 000 FLI 000 000 FMT 000 000
MXR 000 000 --- 000 --- --- 000 MIU --- --- --- --- --- --- --- EOM
M 12:42:10 01,39 609 UTL QRY ALL DS3U 3 LN MSG:
UNIT 08 UC 000 FLI 000 000 FMT 000 000
MXR 000 000 000 --- 111 000 000 MIU --- --- --- --- --- --- --- EOM
M 12:42:10 01,39 609 UTL QRY ALL DS3U 3 LN MSG:
UNIT 09 UC 000 FLI 000 000 FMT 000 000
MXR 000 000 000 000 000 000 000 MIU --- --- --- --- --- --- --- EOM
M 12:42:11 01,39 609 UTL QRY ALL DS3U 3 LN MSG:
UNIT 10 UC 000 FLI 000 000 FMT 000 000
MXR 000 000 000 000 000 000 000 MIU --- --- --- --- --- --- --- EOM
M 12:42:11 01,39 609 UTL QRY ALL DS3U 3 LN MSG:
UNIT 11 UC 000 FLI 000 000 FMT 000 000
MXR 000 000 000 000 000 000 000 MIU --- --- --- --- --- --- --- EOM
M 12:42:11 01,39 609 UTL QRY ALL DS3U 3 LN MSG:
UNIT 12 UC 000 FLI 000 000 FMT 000 000
MXR 000 000 000 000 000 000 000 MIU --- --- --- --- --- --- --- EOM
M 12:42:11 01,39 609 UTL QRY ALL DS3U 3 LN MSG:
UNIT 13 UC 000 FLI 000 000 FMT 000 000
MXR 000 000 000 000 000 101 000 MIU --- --- --- --- --- --- --- EOM
M 12:42:11 01,39 609 UTL QRY ALL DS3U 3 LN MSG:
UNIT 14 UC 000 FLI 000 000 FMT 000 000
MXR 000 000 000 000 000 000 000 MIU --- --- --- --- --- --- --- EOM
M 12:42:12 01,39 609 UTL QRY ALL DS3U 3 LN MSG:
UNIT 15 UC 000 FLI 000 000 FMT 000 000
MXR 000 000 000 000 000 000 000 MIU --- --- --- --- --- --- --- EOM
M 12:42:12 01,39 609 UTL QRY ALL DS3U 3 LN MSG:
UNIT 16 UC 000 FLI 000 000 FMT 000 000
MXR 000 000 000 --- --- --- --- MIU --- --- --- --- --- --- --- EOM
M 12:42:12 01,39 609 UTL QRY ALL FTU NPCS 0001-0040 40 2 LN MSG:
OOS 00 FAIL 00 PEST 00 EOM

The software of the present invention looks at all of the DACS II output and determines whether a fault exists. If a fault is determined to exist, then an email is sent to the appropriate users notifying them that a problem has occurred. For an example, see Table 2.

TABLE 2

| | |
|---|---|
| Location: | “PNBLARJEK06” |
| | *********************************** |
| | COMMAND (1): “UTL::QRY,MEMSTAT!” |
| | MEMORY PROBLEM |
| | ------------------------------------ |
| | COMMAND (2): “UTL::QRY,ALMS!” |
| | Unit 9 DS3 Unit MXR 2 Autonomously Removed |
| | Unit 12 DS3 Unprotected Minor Alarm |
| | ---------------------------------- |
| | COMMAND (3): “UTL::QRY,ALL!” |
| | Link 4 OOS |
| | Unit 12 DS3 6 OOS |
| | Unit 12 DS3 6 PEST |

In particular embodiments, the information from the analysis is also automatically posted to a website as illustrated in Table 3.

TABLE 3
DACS II HEALTH REPORT
This web page list all DACS II Cross Connect Systems in SBC Southwest
that had a standing alarm at the time this report was generated.
Any questions regarding this report contact
Technical Support
email@company.com
555-555-5555
Report Date: Mon Oct 25 04:10:00 CDT 2004
Location: “PNBLARJEK06”
***********************************
COMMAND (1): “UTL::QRY,MEMSTAT!”
MEMORY PROBLEM
------------------------------------
COMMAND (2): “UTL::QRY,ALMS!”
Unit 9 DS3 Unit MXR 2 Autonomously Removed
Unit 12 DS3 Unprotected Minor Alarm
----------------------------------
COMMAND (3): “UTL::QRY,ALL!”
Link 4 OOS
Unit 12 DS3 6 OOS
Unit 12 DS3 6 PEST

Any failures found and emailed or posted to a web page consist of a plain English description of the problem found, which eliminates having to search through a technical manual to decipher the type and severity of a problem.

In a specific embodiment, three computer program commands are set up to automatically be sent to the network elements at 0300 everyday. The response to these commands is automatically emailed to a specified UNIX server. At 0600, for example, the program automatically kicks off the 3 commands and analyzes the data from the responses to the commands. If the program of the invention finds a fault in the command outputs, the program will then post what the fault is on a website. In various embodiments, the software also automatically kicks off an email to a distribution list in the program. The email can go to anybody that requests to be on it. For example, it is sent to an Network Operations Center, where the fault is responded to. The invention automates the whole process, including the emailing of any faults found.

The invention provides a software application that saves time and money, and allows for error-free equipment analysis. For example, each month the present inventor would spend approximately 24 hours analyzing 64 systems for any kind of failures and would then provide the information to the Network Operations Center. Now, the present inventor can analyze a DACS II system in 5 minutes or less.

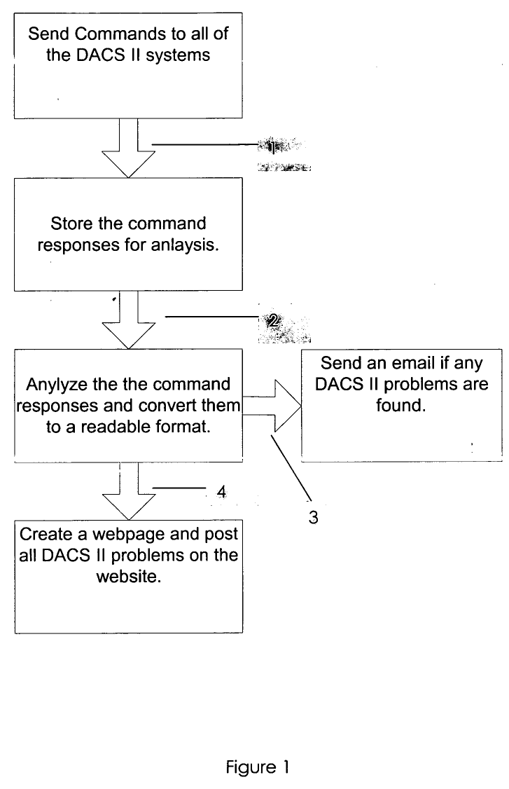

FIG. 1 is a high level logic flow chart diagram of a method of a specific embodiment of the present invention. Telecommunications enterprises typically utilize a large number of DACS II system units to direct digital communications. The present invention, for instance, was developed for use at DACS II center utilizing approximately 64 DACS II units. At step 1 of the method depicted in FIG. 1, commands are sent to all of the DACS II systems of the enterprise. Sample commands include MEMSTAT!, which queries the status of the memory and lists any problems detected; as illustrated in Table 4.

TABLE 4
UTL::QRY,MEMSTAT!

NE RESPONSE: M 03:03:06 03,22 602 UTL QRY MEMSTAT 5 LN MSG:

| DEV | EXCT | DBASE | DATE | TIME | FID | UID | |
|---|---|---|---|---|---|---|---|
| RAM | 08.02.6 | 08.02.6 | 10/25/04 | 03:03:05 | 03 | HSTNTXCLK03 | |
| PMEM | 08.02.6 | 08.02.6 | 10/25/04 | 00:29:27 | 03 | HSTNTXCLK03 | |
| SMEM | 08.02.6 | 08.02.6 | 10/25/04 | 00:29:27 | 03 | HSTNTXCLK03 | EOM |

M 03:03:06 03,22 602 UTL QRY MEMSTAT 5 LN MSG:

| | | | | |
|---|---|---|---|---|
| FPKG | DBSN | FCSN | STATE | |
| 00000B9D | 5.0 | 5.0 | OOS | |
| 00000B9D | 5.0 | 00000155000000802666 | IS | |
| 00000B9D | 5.0 | 00000155000000807668 | IS | COMPL |

ALMS!, which queries the system's alarms and lists any alarms in the system; as illustrated in Table 5.

TABLE 5
UTL::QRY,ALMS!

```
    NE RESPONSE: M 03:02:42 01,10 602 UTL QRY ALMS SUMMARY CR 1 MJ 1
    MN 1 MC 0 PWR 0 EOM
    M 03:02:42 01,10 602 UTL QRY ALMS PWR 2 LN MSG:
    - - - - - - - - - - - - - - - - - - - - EOM
    M 03:02:42 01,10 602 UTL QRY ALMS - - - - - - - - - - - - - - - -
- - - EOM
    M 03:02:42 01,10 602 UTL QRY ALMS 3 LN MSG:
    SYNC - - CRO -
    TLI - - - - - - - - - - - - - - - - EOM
    M 03:02:42 01,10 602 UTL QRY ALMS TOTAL ETSIS 30 00 3 LN MSG:
    01 - - 02 - - 03 - - 04 - - 05 - - 06 - - 07 - - 08 - -
    09 - - 10 - - 11 - - 12 - - 13 - - 14 - - 15 - - 16 - - EOM
    M 03:02:42 01,10 602 UTL QRY ALMS 6 LN MSG:
    UNIT 01 UC - FTMI - - - - FC - - - - - - - -
    UNIT 02 UC - FTMI - - - - FC - - - - - - - -
    UNIT 03 UC - FTMI - - - - FC - - - - - - - -
    UNIT 04 UC - FTMI - - - - FC - - - - - - - -
    EOM
    M 03:02:42 01,10 602 UTL QRY ALMS 8 LN MSG:
    UNIT 05 UC - FLI - - FMT - - MXR - - - - - - - MIU - - - - - - -
        DU -
    UNIT 07 UC - FTMI - - - - FC - - - - - - - -
    UNIT 08 UC - FTMI - - - - FC - - - - - - - -
    UNIT 09 UC - FLI - - FMT - - MXR - - a - - - - MIU - - - - - - -
        DU -
    EOM
    M 03:02:42 01,10 602 UTL QRY ALMS 9 LN MSG:
    UNIT 10 UC - FLI - - FMT - - MXR - - - - - - - MIU - - - - - - -
        DU -
    UNIT 11 UC - FTMI - - - - FC - - - - - - - -
    UNIT 12 UC - FLI - - FMT - - MXR - - - - - - - MIU - - - - - - -
        DU *
    UNIT 13 UC - FLI - - FMT - - MXR - - - - - - - MIU - - - - - - -
        DU -
    EOM
    M 03:02:42 01,10 602 UTL QRY ALMS 7 LN MSG:
    UNIT 14 UC - FLI - - FMT - - MXR - - - - - - - MIU - - - - - - -
        DU -
    UNIT 15 UC - FLI - - FMT - - MXR - - - - - - - MIU - - - - - - -
        DU -
    UNIT 16 UC - FTMI - - - - FC - - - - - - - -
    EOM
    M 03:02:44 01,10 602 UTL QRY ALMS DS3 42 5 LN MSG:
    UNIT 05 - - - - - - ALMS 06
    UNIT 09 - - - C C C
    UNIT 10 - - - - - -
    UNIT 12 - - - - - - EOM
    M 03:02:44 01,10 602 UTL QRY ALMS DS3 42 4 LN MSG:
    UNIT 13 - - - - I - ALMS 06
    UNIT 14 - - - - - -
    UNIT 15 - I - I - - EOM
```

The ALL! command lists the service state of all common equipment in the DACS II system; as illustrated in Table 6.

TABLE 6
UTL::QRY,ALL!

```
    NE RESPONSE: M 03:06:13 01,12 602 UTL QRY
    ALL COMMON 4 LN MSG:
    OOS 0 0 0 0 1 0 0 0 0 0
    FAIL - - - - - - - - 0 0
    PEST - - - - - - 0 0 0 0 EOM
    M 03:06:16 01,12 602 UTL QRY ALL COMMON 4 LN MSG:
    SYNC 000 000 CRO ---
    TLI --- --- --- --- --- --- 000 000 --- --- --- --- --- ---
    000 000
      - - - - - - 1 2 - - - - - -
1 2 EOM
    M 03:06:20 01,12 602 UTL QRY ALL TOTAL ETSIS 30 00 00 00 5
    LN
MSG:
    01 000 000 02 000 000 03 000 000 04 000 000
    05 000 000 06 --- --- 07 000 000 08 000 000
    09 000 000 10 000 000 11 000 000 12 000 000
    13 000 000 14 000 000 15 000 000 16 000 000 EOM
    M 03:06:27 01,12 602 UTL QRY ALL FTU 3 LN MSG:
    UNIT 01 UC 000 FTMI 000 000 000 000
    FC 000 000 000 000 000 000 000 000 EOM
    M 03:06:30 01,12 602 UTL QRY ALL FTU 3 LN MSG:
    UNIT 02 UC 000 FTMI 000 000 000 000
    FC 000 000 000 000 000 000 000 000 EOM
    M 03:06:33 01,12 602 UTL QRY ALL FTU 3 LN MSG:
    UNIT 03 UC 000 FTMI 000 000 000 000
    FC 000 000 000 000 000 000 000 000 EOM
    M 03:06:34 01,12 602 UTL QRY ALL FTU 3 LN MSG:
    UNIT 04 UC 000 FTMI 000 000 000 000
    FC 000 000 000 000 000 000 000 000 EOM
    M 03:06:38 01,12 602 UTL QRY ALL DS3U 3 LN MSG:
    UNIT 05 UC 000 FLI 000 000 FMT 000 000
    MXR 000 000 000 000 000 000 000 MIU --- --- --- --- --- --- ---
EOM
    M 03:06:42 01,12 602 UTL QRY ALL FTU 3 LN MSG:
    UNIT 07 UC 000 FTMI 000 000 000 000
    FC 000 000 000 000 000 000 000 000 EOM
    M 03:06:45 01,12 602 UTL QRY ALL FTU 3 LN MSG:
    UNIT 08 UC 000 FTMI 000 000 000 000
    FC 000 000 000 000 000 000 000 000 EOM
    M 03:06:49 01,12 602 UTL QRY ALL DS3U 3 LN MSG:
    UNIT 09 UC 000 FLI 000 000 FMT 000 000
    MXR 000 000 000 000 000 000 000 MIU --- --- --- --- --- --- ---
EOM
    M 03:06:52 01,12 602 UTL QRY ALL DS3U 3 LN MSG:
    UNIT 10 UC 000 FLI 000 000 FMT 000 000
    MXR 000 000 000 000 000 000 000 MIU --- --- --- --- --- --- ---
    EOM
    M 03:06:55 01,12 602 UTL QRY ALL FTU 3 LN MSG:
    UNIT 11 UC 000 FTMI 000 000 000 000
    FC 000 000 000 000 000 000 000 000 EOM
    M 03:06:59 01,12 602 UTL QRY ALL DS3U 3 LN MSG:
    UNIT 12 UC 000 FLI 000 000 FMT 000 000
    MXR 000 000 000 000 000 000 101 MIU --- --- --- --- --- --- ---
EOM
    M 03:07:02 01,12 602 UTL QRY ALL DS3U 3 LN MSG:
    UNIT 13 UC 000 FLI 000 000 FMT 000 000
    MXR 000 000 000 000 000 000 000 MIU --- --- --- --- --- --- ---
EOM
    M 03:07:06 01,12 602 UTL QRY ALL DS3U 3 LN MSG:
    UNIT 14 UC 000 FLI 000 000 FMT 000 000
    MXR 000 000 000 000 000 000 000 MIU --- --- --- --- --- --- ---
EOM
    M 03:07:10 01,12 602 UTL QRY ALL DS3U 3 LN MSG:
    UNIT 15 UC 000 FLI 000 000 FMT 000 000
    MXR 000 000 000 000 000 000 000 MIU --- --- --- --- --- --- ---
EOM
    M 03:07:14 01,12 602 UTL QRY ALL FTU 3 LN MSG:
    UNIT 16 UC 000 FTMI 000 000 000 000
    FC 000 000 000 000 000 000 000 000 EOM
```

Each unit of the DACS system responds to the commands (1) Step 2 of the method of FIG. 1 is to store the responses for analysis. Step 3 is to analyze the command responses and convert each response to a readable format (2) to create a report. Members of the enterprise with an interest in the status of the DACS II system opt into an email recipient list (3). At step 4, the invention automatically emails the report to the email recipients on the list. Alternatively, or additionally, (4) a step five is included where a url is assigned and the report is posted on a webpage at the url. In certain embodiments, access to the webpage is password protected.

A sample Error Report of a specific embodiment of the invention is shown is Table 7.

TABLE 7
EXAMPLE OF “FAILURE” EMAIL GENERATED
BY THE SOFTWARE PROGRAM:

Location: “KSCYMO21K01”
***********************************
COMMAND (1): “UTL::QRY,MEMSTAT!”
------------------------------------
COMMAND (2): “UTL::QRY,ALMS!”
XC 1 Major Alarm
SYNC 1 Autonomously Removed
----------------------------------
COMMAND (3): “UTL::QRY,ALL!”
XC 1 OOS
XC 1 PESTED
CCI 1 PESTED
SYNC 1 OOS
ETSI 1 Side 1 PESTED
ETSI 2 Side 1 PESTED
ETSI 5 Side 1 PESTED
Unit 1 FTU FTM 1 FC 1 PEST
Unit 1 FTU FTM 2 FC 1 PEST
Unit 1 FTU FTM 3 FC 1 PEST
Unit 1 FTU FTM 4 FC 1 PEST
Unit 2 FTU FTM 1 FC 1 PEST
Unit 2 FTU FTM 2 FC 1 PEST
Unit 2 FTU FTM 3 FC 1 PEST
Unit 2 FTU FTM 4 FC 1 PEST
Unit 5 FTU FTM 1 FC 1 PEST
Unit 5 FTU FTM 2 FC 1 PEST
Unit 5 FTU FTM 3 FC 1 PEST
Unit 5 FTU FTM 4 FC 1 PEST
***********************************

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. A method for automatically analyzing the output of a digital cross-connect system in a telecommunications network, the method comprising the steps of:
sending at least one command to at least one digital cross-connect system for a response from the system;
storing a response to the command for analysis;
analyzing the stored command response;
converting the analyzed response to a selected format; and
publishing the formatted response.

2. The method of claim 1, wherein the digital cross connect system comprises at least one DACS II system.

3. The method of claim 1, wherein the command comprises a MEMSTAT! Query to query the status of the memory.

4. The method of claim 3, wherein the published response comprises a list of any memory problems detected.

5. The method of claim 1, wherein the command comprises an ALMS! Query to query the system's alarms.

6. The method of claim 5, wherein the published response comprises a list of one more alarm in the system.

7. The method of claim 1, wherein the command comprises an ALL! Query to query the service state of equipment in the system.

8. The method of claim 7, wherein the published response comprises a list of the service state of all common equipment in the system.

9. The method of claim 1, wherein the step of publishing the response comprises sending email.

10. The method of claim 1, wherein the step of publishing the response comprises posting to a web page.

11. A system to automatically analyze the output of a digital cross-connect system in a telecommunications network, the system comprising
means for sending at least one command to at least one digital cross-connect system for a response from the system;
means for storing a response to the command for analysis;
means for analyzing the stored command response;
means for converting the analyzed response to a selected format; and
means for publishing the formatted response.

12. The system of claim 11, wherein the digital cross-connect system comprises at least one DACS II system.

13. The system of claim 11, wherein the command comprises a MEMSTAT! Query to query the status of the memory.

14. The system of claim 13, wherein the published response comprises a list of any memory problems detected.

15. The system of claim 11, wherein the command comprises an ALMS!, Query to query the system's alarms.

16. The system of claim 15, wherein the published response comprises a list of one more alarm in the system.

17. The system of claim 1, wherein the command comprises an ALL! Query to query the service state of selected equipment in the system.

18. The system of claim 7, wherein the published response comprises a list of the service state of selected equipment in the system.

19. The system of claim 1, wherein the means for publishing the response is electronic mail.

20. The system of claim 1, wherein the means for publishing the response is a web page.
